(19) United States
(12) Patent Application Publication
(10) Pub. No.: US 2008/0120181 A1
(43) Pub. Date: May 22, 2008

(54) Advertisement playing and monitoring system

(76) Inventors: Son-Yao Chang, Taipei (TW); Hung-Chen Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/648,586

(22) Filed: Jan. 3, 2007

(30) Foreign Application Priority Data
Nov. 17, 2006 (TW) 95220340

(51) Int. Cl. G06Q 30/00

(52) U.S. Cl. 705/14

(57) ABSTRACT

An advertisement playing and monitoring system uses a remote control system to transmit an advertisement file to an advertisement processing machine. The advertisement processing machine stores the advertisement file in a storage unit and plays the advertisement file on a display unit by an image-processing unit. The advertisement processing machine utilizes the image-processing unit to store the images of the display unit in the storage unit for being viewed by a remote monitoring system. Alternatively, the remote control system plays the advertisement file on the display unit via the advertisement processing machine. The remote monitoring system receives the images of the display unit via the advertisement processing machine.

### BACKGROUND OF THE INVENTION

1. Field of the Invention

The present invention relates to an advertisement playing and monitoring system. In particular, this invention utilizes a remote control system to transmit an advertisement file to a display screen, and a remote monitoring system to monitor the images on the display screen.

2. Description of the Related Art

Because the Internet has rapidly developed and flat display screens have become popular, display screens are now installed in many public places, such as buses, or subway stations, to show dynamic advertisements, including images and audio. Furthermore, Internet technology is used for updating the content of advertisements shown on the display screens so as to reduce required manpower.

FIG. 1 shows an Internet advertising system of the prior art. The advertising system includes a remote control system 1a, an Internet advertising machine 2a, and a display screen 3a. The remote control system 1a uses the Internet to transmit the advertisement file to a storage unit 21a of the Internet advertising machine 2a and stores the advertisement file in the storage unit 21a. The Internet advertising machine 2a plays the stored advertisement file on the display screen 3a in a predetermined order.

However, the advertisement agency does not know whether the Internet advertising machine 2a and the display screen 3a are operating normally or not. Furthermore, because the advertisement file has been updated to the Internet advertising machine 2a via the Internet, workers do not routinely check it. When the Internet advertising machine 2a and the display screen 3a operate abnormally, the Internet advertising machine 2a and the display screen 3a will most likely not be repaired in a timely fashion. For advertisers, they do not know whether the advertisement agency has played the advertisement according to their contract, including the playing frequency, and the playing time, etc.

### SUMMARY OF THE INVENTION

One particular aspect of the present invention is to provide an advertisement playing and monitoring system. It uses the Internet to transmit an advertisement file and plays the advertisement file on the advertisement processing machine, and monitors the images on the display unit via the Internet and the advertisement processing machine.

The advertisement playing and monitoring system includes a display unit, an advertisement processing machine, a remote control system, and a remote monitoring system. The advertisement processing machine plays the advertisement on the display unit and records the images of the display unit into a storage unit. The remote control system transmits the advertisement to the advertisement processing machine via the Internet. The remote monitoring system is linked to the advertisement processing machine via the Internet for receiving the images of the display unit recorded in the storage unit.

The present invention also provides an advertisement processing machine for monitoring the images displayed on the display unit. The advertisement processing machine includes an Internet control unit for transmitting and receiving the advertisement file, a storage unit for storing the advertisement file received by the Internet control unit and transmitting the advertisement file to the Internet control unit, an image-decoding unit for playing the advertisement file of the storage unit on the display unit, and an image-encoding unit for recording the images of the display unit into the storage unit and transmitting the images of the display unit to the Internet control unit.

The present invention utilizes a remote monitoring system to monitor the images of the display unit, and checks whether the Internet advertising machine and the display unit are operating correctly or not. For advertisers, they can know whether the advertisement agency is playing the advertisement according to their contract, including playing frequency, and playing time, etc, via the remote monitoring system.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the Internet advertising system of the prior art;

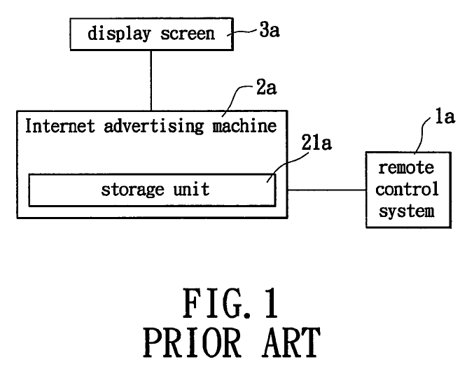

FIG. 2 is a block diagram of the advertisement playing and monitoring system of the first embodiment of the present invention; and

FIG. 3 is a block diagram of the advertisement playing and monitoring system of the second embodiment of the present invention.

### DETAILED DESCRIPTION OF THE PREFERRED EMBODIMENTS

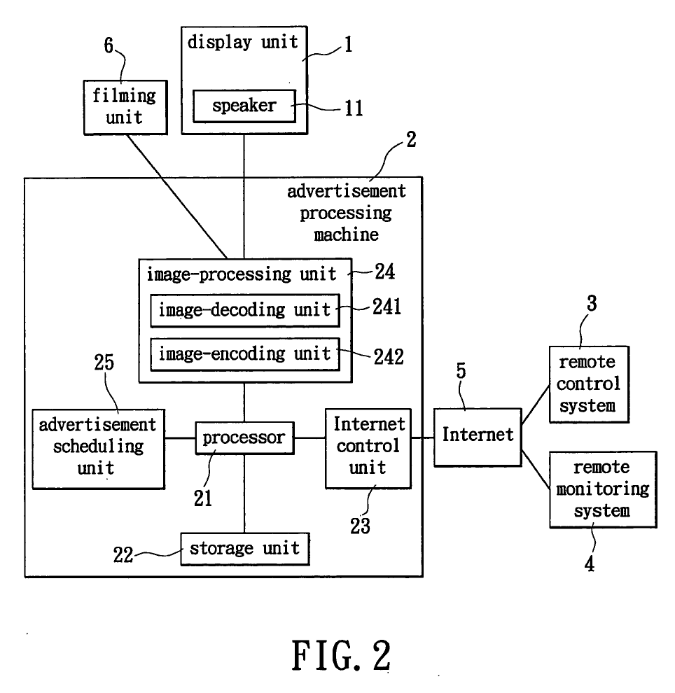

Reference is made to FIG. 2, which shows a block diagram of the advertisement playing and monitoring system of the first embodiment of the present invention. The advertisement playing and monitoring system includes a display unit 1, an advertisement processing machine 2, a remote control system 3, a remote monitoring system 4, and an Internet 5.

The display unit 1 is used for displaying advertisements to a viewer. The number of the display unit 1 is determined by requirements, and is not limited to one. The display unit 1 can be a liquid crystal display, a plasma display, a CRT display, or a back-projecting display or projector. The display unit 1 has a speaker 11 for playing the audio. The display unit 1 also can be integrated with the advertisement processing machine 2 into one piece. This means that the display unit 1 and the advertisement processing machine 2 are located within a housing (not shown in the figure).

The advertisement processing machine 2 includes a processor 21, a storage unit 22, an Internet control unit 23, and an image-processing unit 24. The processor 21 controls the operations of the units in the advertisement processing machine 2. The storage unit 22 is used for storing the advertisement file. The storage unit 22 can be a hard disk, an optical drive, a memory, or a flash card, etc. The Internet control unit 23 is used for connecting the remote control system 3 and the remote monitoring system 4 and receiving the advertisement file or a variety of control data.

The image-processing unit 24 includes an image-decoding unit 241 for decoding the advertisement file in the storage unit 22, and playing the advertisement file on the display unit 1 (alternatively, the image-decoding unit 241 directly processes the advertisement file transmitted by the remote control system 3 via the Internet control unit 23 and plays the advertisement file on the display unit 1), and an image-encoding unit 242 for continuously obtaining the image of the display unit 1 and encoding the image into video format, such as AVI, MPAG2, MPAG4, etc, and recording the recording time to store the data in the storage unit 1 or transmit the video signals to the remote monitoring system 4 via the Internet control unit 23.

The present invention further includes an advertisement scheduling unit 25. The advertisement scheduling unit 25 can be a software program, is stored in the storage unit 22, and is operated by the processor 21. The advertisement scheduling unit 25 makes a playing list for the advertisement in the storage unit 22 according to their playing order, playing time, and playing numbers, etc. The playing list is a data file and is stored in the storing unit 22. The processor 22 operates the advertisement scheduling unit 25 and plays the advertisement in the storage unit 22 via the image-processing unit 24 onto the display unit 1 according to the playing list. The advertisement scheduling unit 25 can also be operated by the remote control system 3 so as to update and make the playing list.

The remote control system 3 transmits the advertisement to the advertisement processing machine 2 via the Internet 5, and plays the advertisement on the display unit 1 via the advertisement processing machine 2. The remote control system 3 stores the advertisement in the storage unit 22 of the advertisement processing machine 2 in advance and sets the advertisement scheduling unit 25 to play the advertisement in the storage unit 22 on the display unit 1. Alternatively, the remote control system 3 uses an Internet streaming technology to directly play the advertisement on the display unit 1 via the advertisement processing machine 2. The remote control system 3 can actively detect and repair the advertisement processing machine 2, such as detecting whether the advertisement processing machine 2 is operating normally or not, and turning on or shutting down the advertisement processing machine 2. Thereby, the time and cost of sending a worker to a specific location to repair the advertisement processing machine 2 is reduced.

The remote monitoring system 4 is connected with the advertisement processing machine 2 via the Internet 5, and is connected with the image-processing unit 24 for receiving images and monitoring whether the displayed images are normal. Alternatively, the remote monitoring system 4 is connected with the advertisement processing machine 2 via the Internet 5, and is connected with the storage unit 22 for receiving the images of the display unit 1 recorded by the image-processing unit 24 and receiving the recording time. Thereby, the advertisement agency knows whether the display unit 1 is operating abnormally or not, and ensures that repairs to the display unit 1 and performed in a timely fashion. The remote monitoring system 4 can be a program, and can be installed to a PC of the advertiser. Thereby, the advertiser can monitor the advertisement in any time to evaluate the advertisement's effect.

The Internet 5 can be an Intranet or a wireless network.

The advertisement playing and monitoring system further includes a filming unit 6. The filming unit 6 can be a camera or a monitoring camera. The filming unit 6 films the viewer that is viewing the display unit 1, or films the display unit 1. The filmed image is stored in the storage unit 22 or is directly watched by the remote monitoring system 4. Therefore, the advertisement agency can evaluate the effectiveness of the advertisement.

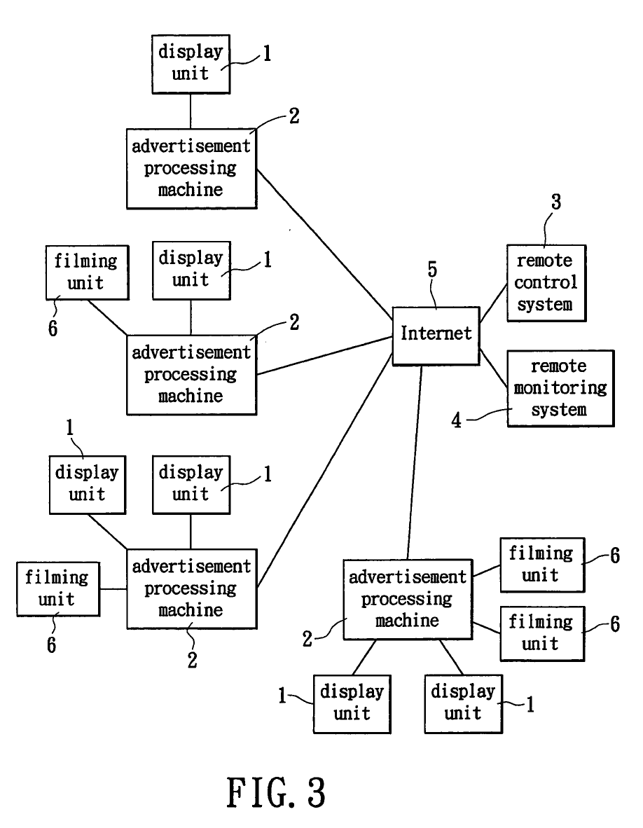

Reference is made to FIG. 3, which shows a block diagram of the advertisement playing and monitoring system of the second embodiment of the present invention. There is a plurality of advertisement processing machines 2. There can be one or more than one of the display units 1 connected with the advertisement processing machine 2. More than one filming unit 6 is not required. The remote control system 3 and the remote monitoring system 4 selectively control one of the advertisement processing machines 2, the display unit 1, or the filming unit 6. Alternatively, the remote control system 3 and the remote monitoring system 4 control the advertisement processing machine 2, the display unit 1, and the filming unit 6 at the same time. The remote monitoring system 4 can display more than one image of the display unit 1 and/or filming unit 6, or more than one file of the storage unit 22 of the advertisement processing machine 2.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An advertisement playing and monitoring system, comprising:
a display unit;
an advertisement processing machine playing an advertisement on the display unit and recording images of the display unit into a storage unit;
a remote control system transmitting the advertisement to the advertisement processing machine via the Internet; and
a remote monitoring system linked to the advertisement processing machine via the Internet for receiving the images of the display unit recorded in the storage unit.

2. The advertisement playing and monitoring system as claimed in claim 1, wherein the display unit and the advertisement processing machine are integrated into one piece.

3. The advertisement playing and monitoring system as claimed in claim 1, wherein the advertisement processing machine has an image-processing unit for decoding a file of the storage unit and playing the file on the display unit.

4. The advertisement playing and monitoring system as claimed in claim 3, wherein the image-processing unit records the images of the display unit into the storage unit.

5. The advertisement playing and monitoring system as claimed in claim 1, wherein the advertisement processing machine has an advertisement scheduling unit for scheduling an advertisement file in the storage unit and playing the advertisement file onto the display unit.

6. The advertisement playing and monitoring system as claimed in claim 5, wherein the advertisement scheduling unit is a software program.

7. The advertisement playing and monitoring system as claimed in claim 5, wherein the remote control system is linked to the advertisement processing machine for operating the advertisement scheduling unit.

8. The advertisement playing and monitoring system as claimed in claim 1, further comprising a filming unit that filmed image is stored in the storage unit of the advertisement processing machine.

9. The advertisement playing and monitoring system as claimed in claim 8, wherein the remote monitoring system obtains the image taken by the filming unit via the advertisement processing machine.

10. The advertisement playing and monitoring system as claimed in claim 8, wherein the remote monitoring system obtains the image taken by the filming unit in the storage unit via the advertisement processing machine.

11. The advertisement playing and monitoring system as claimed in claim 1, wherein the remote monitoring system obtains images played in the display unit via the advertisement processing machine.

12. The advertisement playing and monitoring system as claimed in claim 1, wherein the Internet is an Intranet or a wireless network.

13. An advertisement processing machine, for monitoring images displayed on a display unit, comprising:
an Internet control unit for transmitting and receiving an advertisement file;
a storage unit for storing the advertisement file received by the Internet control unit and transmitting the advertisement file to the Internet control unit;
an image-decoding unit for playing the advertisement file in the storage unit on the display unit; and
an image-encoding unit for recording images of the display unit into the storage unit and transmitting the images of the display unit to the Internet control unit.

14. The advertisement processing machine as claimed in claim 13, further comprising a processing for controlling operations of all units in the advertisement processing machine.

15. The advertisement processing machine as claimed in claim 13, further comprising an advertisement scheduling unit for scheduling the advertisement file in the storage unit to play on the display unit.

16. The advertisement processing machine as claimed in claim 15, wherein the advertisement scheduling unit is a software program.

17. The advertisement processing machine as claimed in claim 13, further comprising a filming unit, wherein the filmed image is stored in the storage unit via the image-decoding unit.

18. The advertisement processing machine as claimed in claim 17, wherein images taken by the filming unit are transmitted by the Internet control unit.
